(19) United States
(12) Patent Application Publication
(10) Pub. No.: US 2026/0128189 A1
(43) Pub. Date: May 7, 2026

(54) TRAPPING OF SINGLE ULTRACOLD ATOMS AND MOLECULES IN METASURFACE OPTICAL TWEEZER ARRAYS

(71) Applicant: THE TRUSTEES OF COLUMBIA UNIVERSITY IN THE CITY OF NEW YORK, New York, NY (US)

(72) Inventors: Sebastian Will, New York, NY (US); Nanfang Yu, Fort Lee, NJ (US); Aaron Holman, New York, NY (US); Yuan Xu, New York, NY (US); Ximo Sun, New York, NY (US); Jiahao Wu, New York, NY (US); Bojeong Seo, New York, NY (US)

(73) Assignee: THE TRUSTEES OF COLUMBIA UNIVERSITY IN THE CITY OF NEW YORK, New York, NY (US)

(21) Appl. No.: 19/383,101

(22) Filed: Nov. 7, 2025

Related U.S. Application Data
(60) Provisional application No. 63/717,627, filed on Nov. 7, 2024.

(51) Int. Cl. G21K 1/30; G01N 21/64

(52) U.S. Cl. CPC G21K 1/30; G01N 21/6456

(57) ABSTRACT

The disclosed subject matter relates to systems and methods for trapping single atoms and molecules using metasurface-generated optical tweezer arrays. A metasurface, comprising a plurality of subwavelength-spaced pixels fabricated from dielectric materials, is configured to generate an optical tweezer array from an incident laser beam in which particles are trapped. The metasurface enables the creation of highly uniform and scalable tweezer arrays with arbitrary geometries, dimensionalities, and trap spacings, supporting array sizes exceeding 10,000 traps. The compact, robust design and high power-handling capabilities of the metasurface facilitate direct trapping of ultracold particles, such as strontium atoms, with a vacuum chamber, and allow for field-deployable quantum devices. The disclosed approach achieves high uniformity in trap intensity and position, enabling advanced quantum applications.

### CROSS REFERENCE TO RELATED APPLICATIONS

This Non-Provisional application claims priority to the U.S. Provisional Application Ser. No. 63/717,627, filed on Nov. 7, 2024, the contents of which are hereby incorporated by reference in its entirety.

### STATEMENT REGARDING FEDERALLY SPONSORED RESEARCH

This invention was made with government support under 1936359, 2040702 and 2004685 awarded by the National Science Foundation and under FA95500-16-1-0322 and FA9550-23-1-0404 awarded by the Air Force Office of Scientific Research. The government has certain rights in the invention.

### BACKGROUND

The disclosed subject matter relates to optical tweezer arrays for use in quantum applications.

Optical tweezer arrays can control ultracold particles in quantum applications, including quantum computing, simulation, and metrology. Applications include quantum spin systems, high-fidelity Rydberg quantum gates, error-corrected quantum computation, optical tweezer clocks, and cavity quantum electrodynamics and correlated atom-photon interactions.

The ability to generate high-quality optical tweezer arrays is required for certain use cases. A tweezer array can include numerous tightly focused laser beams, each constituting a trap for a single particle. Important criteria for the platform can include trap uniformity and scalability.

Certain optical tweezer arrays are generated via active beam-shaping devices, such as acousto-optical deflectors (AODs), liquid crystal-spatial light modulators (SLMs), or digital micromirror devices (DMDs). These devices can require complex control electronics and projection optics with high numerical apertures (NA) to relay the tweezer arrays onto ultracold particles. The NA measures the angular range within which an optical system can focus or collect light. Technical complexity and limitations can constrain array sizes to ˜10,000 traps, which can limit the quantum applications that can be pursued. Certain alternative techniques, such as amplitude masks and microlens arrays, have limited beam-shaping capabilities and present challenges to achieving highly uniform arrays.

Holographic metasurfaces can be used to generate versatile and scalable tweezer arrays. Metasurfaces can be flat optical devices comprised of pixels and can imprint an arbitrary phase mask onto an incident laser beam-generating and focusing an optical tweezer array. Metasurfaces can provide high power-handling capabilities, diffraction-limited focusing, and polarization control.

There exists a need for improved optical tweezer arrays.

### SUMMARY

The disclosed subject matter provides techniques for trapping ultracold particles using an incident laser beam. An example system can include a metasurface with multiple subwavelength-spaced pixels which can imprint a phase profile on the incident laser beam. The metasurface can generate an optical tweezer array from the incident laser beam. The metasurface can be fabricated from dielectric materials. The optical tweezer array can include multiple traps.

In certain embodiments, the metasurface can generate and focus the optical tweezer array. In certain embodiments, the metasurface can generate the optical tweezer array in conjunction with focusing optics.

In certain embodiments, the system can include a vacuum chamber. In additional embodiments, the metasurface can be either located inside or outside the vacuum chamber. In additional embodiments, the system can include relay optics which can be located between the metasurface and the particles.

In certain embodiments, the optical tweezer array has an arbitrary geometry and an arbitrary dimensionality. In certain embodiments, the optical tweezer array can be one-dimensional, two-dimensional, or three-dimensional. In certain embodiments, the dielectric materials can have high refractive indexes. In certain embodiments, the metasurface can have a numerical aperture greater than 0.3. In certain embodiments, the pixels can have a cross-sectional cell size of approximately 5% to 100% of the wavelength of the incident laser beam, and a height of approximately 10% to 300% of the wavelength of the incident laser beam. In certain embodiments, the incident laser beam can have a wavelength ranging from 100 to 10000 nanometers.

In certain embodiments, the plurality of traps can trap ultracold particles. In certain embodiments, the ultracold particles can be strontium atoms. In certain embodiments, the traps can have intensity uniformity greater than 90%.

In certain embodiments, the plurality of traps can have over 10,000 traps.

The disclosed subject matter also provides methods for trapping single particles. An example method can include directing a laser beam onto a metasurface with subwavelength pixels, modulating the phase of the laser beam using the metasurface, which can generate an optical tweezer array, and trapping particles in the optical tweezer array. In certain embodiments, the metasurface can generate and focus the optical tweezer array. In certain embodiments, the metasurface can generate the optical tweezer array in conjunction with focusing optics. In certain embodiments, the method can include detecting trapped particles via fluorescence imaging using a high-numerical-aperture lens and a camera.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated and constitute part of this disclosure, illustrate preferred embodiments of the disclosed subject matter and serve to explain the principles of the disclosed subject matter.

FIG. 1A illustrates an example of a metasurface-generated optical tweezer array in accordance with the disclosed subject matter.

FIG. 1B illustrates an example of a substrate with metasurfaces, pixels, and a library.

FIG. 1C illustrates an energy-level diagram of an example metasurface-trapped particle.

FIG. 1D illustrates an example metasurface-generated optical tweezer array in accordance with the disclosed subject matter.

FIG. 2A illustrates fabrication processes of metasurfaces in accordance with the disclosed subject matter.

FIG. 2B illustrates images of metasurfaces.

FIG. 3A illustrates phase response of a pixel library.

FIG. 3B illustrates transmission of a pixel library.

FIG. 4A illustrates particles trapped in an example metasurface-generated optical tweezer array in accordance with the disclosed subject matter.

FIG. 4B illustrates particles trapped in an example metasurface-generated optical tweezer array in accordance with the disclosed subject matter.

FIG. 4C illustrates particles trapped in an example metasurface-generated optical tweezer array in accordance with the disclosed subject matter.

FIG. 4D illustrates particles trapped in an example metasurface-generated optical tweezer array in accordance with the disclosed subject matter.

FIG. 5A illustrates a phase pattern of an example metasurface-generated optical tweezer array in accordance with the disclosed subject matter.

FIG. 5B illustrates a focal plane of the metasurface-generated optical tweezer array of FIG. 5A.

FIG. 6A illustrates an example metasurface in accordance with the disclosed subject matter.

FIG. 6B illustrates an example laser beam profile incident to a metasurface in accordance with the disclosed subject matter.

FIG. 6C illustrates an example laser beam profile incident to a metasurface in accordance with the disclosed subject matter.

FIG. 7A illustrates single-particle preparation and detection in an example metasurface-generated optical tweezer array in accordance with the disclosed subject matter.

FIG. 7B illustrates single-particle preparation and detection in an example metasurface-generated optical tweezer array.

FIG. 7C illustrates single-particle preparation and detection in an example metasurface-generated optical tweezer array.

FIG. 8A illustrates trap depth uniformity in an example metasurface-generated optical tweezer array.

FIG. 8B provides a histogram of trap depth uniformity in an example metasurface-generated optical tweezer array.

FIG. 8C illustrates radial trap frequency uniformity in an example metasurface-generated optical tweezer array.

FIG. 8D provides a histogram of radial frequency uniformity in an example metasurface-generated optical tweezer array.

FIG. 8E illustrates trap position uniformity in an example metasurface-generated optical tweezer array.

FIG. 8F provides a histogram of trap position uniformity in an example metasurface-generated optical tweezer array.

FIG. 9A illustrates an example numerical aperture calculation method in accordance with the disclosed subject matter.

FIG. 9B illustrates an example numerical aperture calculation method in accordance with the disclosed subject matter.

FIG. 10A illustrates performance of a simulated pixel-based beam shaping device.

FIG. 10B illustrates performance of a simulated pixel-based beam shaping device.

FIG. 10C illustrates performance of a simulated pixel-based beam shaping device.

FIG. 10D illustrates performance of a simulated pixel-based beam shaping device.

FIG. 11A illustrates an example large-scale tweezer array in accordance with the disclosed subject matter.

FIG. 11B illustrates an example large-scale tweezer array in accordance with the disclosed subject matter.

FIG. 11C provides a histogram of trap uniformity for an example large-scale tweezer array.

FIG. 12 illustrates edge trap shapes for an example large-scale tweezer array in accordance with the disclosed subject matter.

FIG. 13A illustrates an example of a metasurface-generated optical tweezer array in accordance with the disclosed subject matter.

FIG. 13B illustrates an example of a metasurface-generated optical tweezer array in accordance with the disclosed subject matter.

FIG. 13C illustrates an example of a metasurface-generated optical tweezer array in accordance with the disclosed subject matter.

FIG. 14A illustrates a one-dimensional tweezer array in accordance with the disclosed subject matter.

FIG. 14B illustrates a one-dimensional tweezer array in accordance with the disclosed subject matter.

FIG. 14C illustrates a one-dimensional tweezer array in accordance with the disclosed subject matter.

FIG. 15A illustrates a two-dimensional tweezer array in accordance with the disclosed subject matter.

FIG. 15B illustrates a two-dimensional tweezer array in accordance with the disclosed subject matter.

FIG. 15C illustrates a two-dimensional tweezer array in accordance with the disclosed subject matter.

FIG. 15D illustrates a two-dimensional tweezer array in accordance with the disclosed subject matter.

FIG. 16 illustrates a three-dimensional tweezer array in accordance with the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the FIGs., it is done so in connection with the illustrative embodiments.

### DETAILED DESCRIPTION

As disclosed herein, certain surfaces, called metasurfaces, are designed to control how light behaves—specifically, its phase and amplitude—by using structures built on the surface. These structures, also referred to as pixels, are extremely small and can be made in different shapes and sizes. By arranging these structures in certain patterns, a metasurface can shape light in specific ways, like creating a hologram.

The terms used in this specification generally have their ordinary meanings in the art, within the context of this disclosure, and in the specific context where each term is used. Certain terms are discussed below, or elsewhere in the specification, to provide additional guidance to the practitioner in describing the compositions and methods of the disclosure and how to make and use them.

The terms “about” or “approximately” mean within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

The phrase “highly uniform” refers to a condition in which the variation in key parameters—such as trap depth, trap frequency, and positional accuracy—across an array of optical traps is minimal. For example, a standard deviation of less than 10% in trap depth or frequency, and positional deviations on the order of 1-2% of the trap spacing, can be considered highly uniform.

As used herein, the term “respectively” indicates that items in two or more lists correspond in order, such that each item in one list relates to the item in the same position in the other list.

The phrase “high efficiency” refers to the ability of a metasurface or optical system to convert incident optical power into the desired output pattern with minimal loss. In certain embodiments, this can correspond to a diffraction efficiency of approximately 60% or greater.

The phrase “high power-handling” refers to the capability of an optical system or material to withstand and operate under elevated optical power densities without degradation.

The term “species” refers to a specific atom or molecule type. The term “particle” refers to one quantity of a particular species.

The terms “pixel” or “pixels” refer to nanofabricated structures and/or meta-atoms.

The term “ultracold” refers to temperatures below 1 Kelvin.

The phrase “high refractive index” refers to materials whose refractive index is greater than or equal to 1.5.

The phrases “high NA” or “high numerical aperture” refer to an optical system's ability to focus or collect light over a wide angular range. In the context of a metasurface, a high NA can be greater than 0.3.

The phrase “minimal background light” refers to the condition in which non-modulated or stray optical power is diffusely scattered rather than concentrated, resulting in negligible interference or noise in a focal plane. In certain embodiments, a metasurface can achieve this by scattering residual light over a broad angular range, effectively eliminating bright specular spots and producing a background-free atomic imaging environment.

Metasurfaces can manipulate the amplitude and phase of an optical wavefront in the metasurface plane to holographically control incident light fields. In certain embodiments, the metasurface can be composed of pixels. For example, these pixels can be dielectric nanopillars. The pixels can be a few hundred nanometers in width and a few hundred nanometers in height. For example, in certain embodiments, the pixels can be 10 nm to 1000 nm in width, and 10 nm to 1000 nm in height. In certain embodiments, the pixels can have a height of approximately 10% to 300% of the wavelength of the incident laser beam and a width of approximately 10% to 300% of the wavelength of the incident laser beam. The pixels can be different shapes and sizes. For example, in certain embodiments, the pixels can be circles, squares, X's, O's, and other freeform shapes.

In certain embodiments, the pixels can be positioned in a two-dimensional (2D) grid with subwavelength spacing. This can generate desired optical intensity patterns in one or more of the focal planes of the metasurface.

In certain embodiments, the metasurface can contain at least 106 pixels. In certain embodiments, the metasurface can contain at least 108 pixels. The pixel size of the nanopillars can be 290 nm.

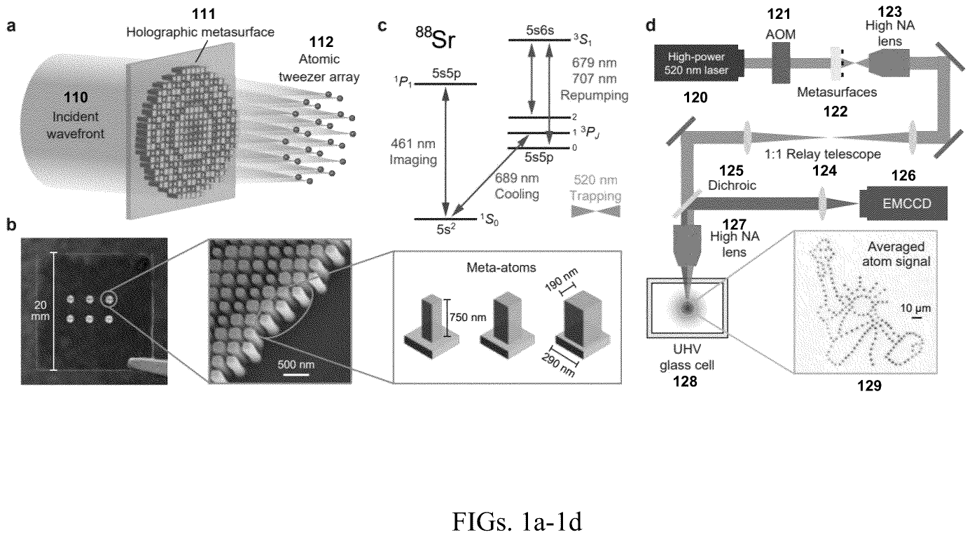

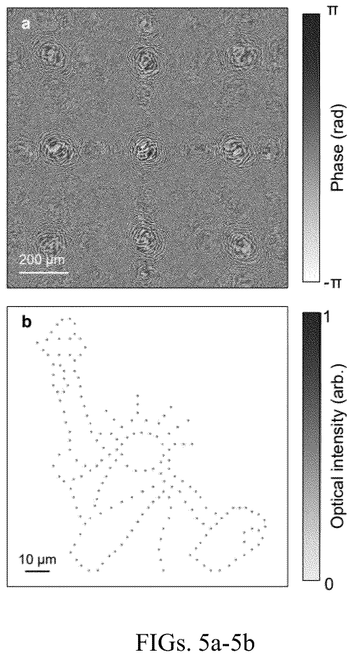

Referring to FIG. 1A, a metasurface 111 can imprint a phase pattern on an incident collimated Gaussian laser beam 110 and produce a two-dimensional array 112 of tight tweezer traps at one or more of its focal planes. The metasurface 111 can be transmitted for visible light at 520 nm. The metasurface 111 can act as a phase-only modulating masks designed using a Gerchberg-Saxton algorithm-based optimization approach. The metasurface 111 can encode a phase pattern that simultaneously generates and focuses a tweezer array 112 from the incident laser beam 110. An example of a phase pattern and the corresponding tweezer array are presented in FIGS. 5A and 5B, respectively.

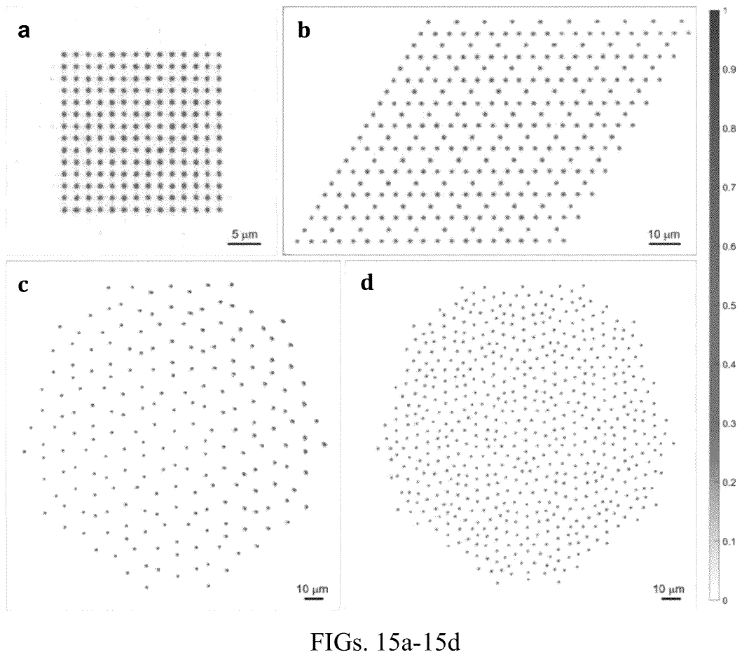

Intensity profiles of example two-dimensional arrays with different geometries are illustrated in FIGS. 15A-15D. A square lattice is illustrated in FIG. 15A. A Kagome lattice is illustrated in FIG. 15B. A Penrose-tiling type quasi-crystal lattice is illustrated in FIG. 15C. A Penrose-tiling type quasi-crystal lattice with reservoir traps is illustrated in FIG. 15D.

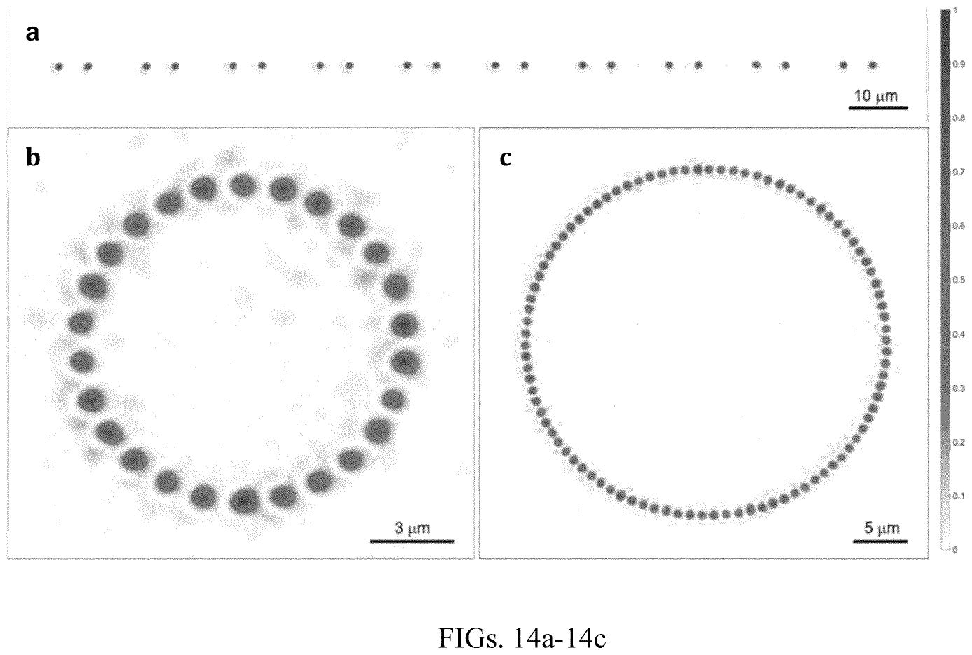

In alternative embodiments, the array can be one-dimensional. Intensity profiles of example one-dimensional arrays with different geometries are illustrated in FIGS. 14A-14C. A dimerized array is illustrated in FIG. 14A. A small ring array is illustrated in FIG. 14B. A large ring array is illustrated in FIG. 14C

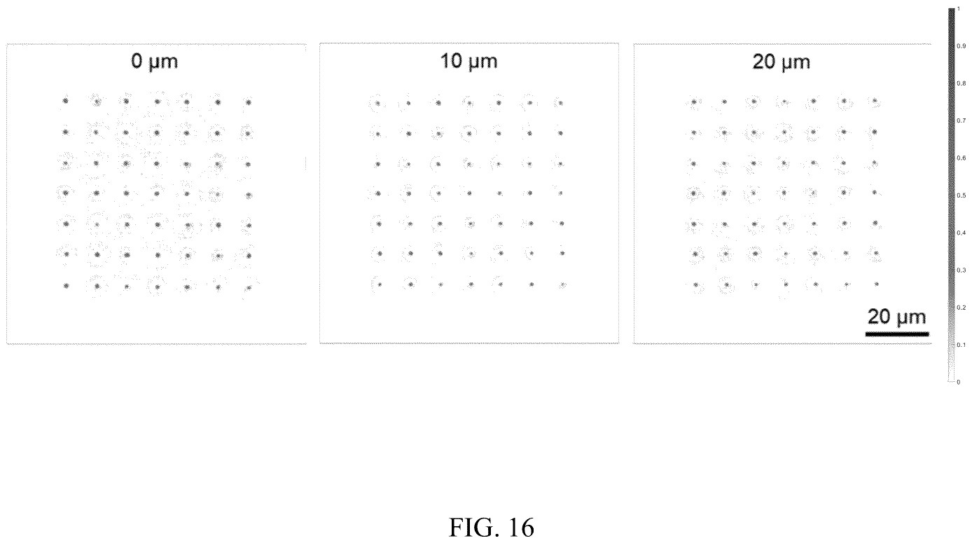

In alternative embodiments, the array can be three-dimensional. Intensity profiles of an example three-dimensional cubic array are illustrated in FIG. 16. The cubic array of FIG. 16 contains three layers, each layer containing 7×7 square lattices. As illustrated in FIG. 16, the intensity profiles are measured at varying distances—0, 10, and 20 μm, respectively—from a metasurface.

Referring to FIG. 1B, multiple metasurfaces can be placed on a single substrate. Zoomed-in views of the pixels, and corresponding pixel library, are illustrated in FIG. 1B. The substrate can be translated and allow for easy switching between distinct tweezer arrays.

In certain embodiments, the metasurfaces can be implemented on complementary dielectric platforms.

An example dielectric platform can be silicon-rich silicon nitride (SRN). SRN thin films are deposited by high-rate plasma-enhanced chemical-vapor deposition (PECVD) directly onto fused-silica wafers. Varying the ratios of the precursor gases (for example, SiH₄, N₂, and NH₃) used in the PECVD process allows for precise control over the real part of the complex refractive index, n, of the SRN films, which can be adjusted from 1.9 to 3.1. In certain embodiments, 750-nm-thick SRN films with n=2.3 and negligible extinction are used. The resulting SRN metasurfaces can achieve high forward-scattering efficiency and withstand high continuous intensities of at least 25 W/mm².

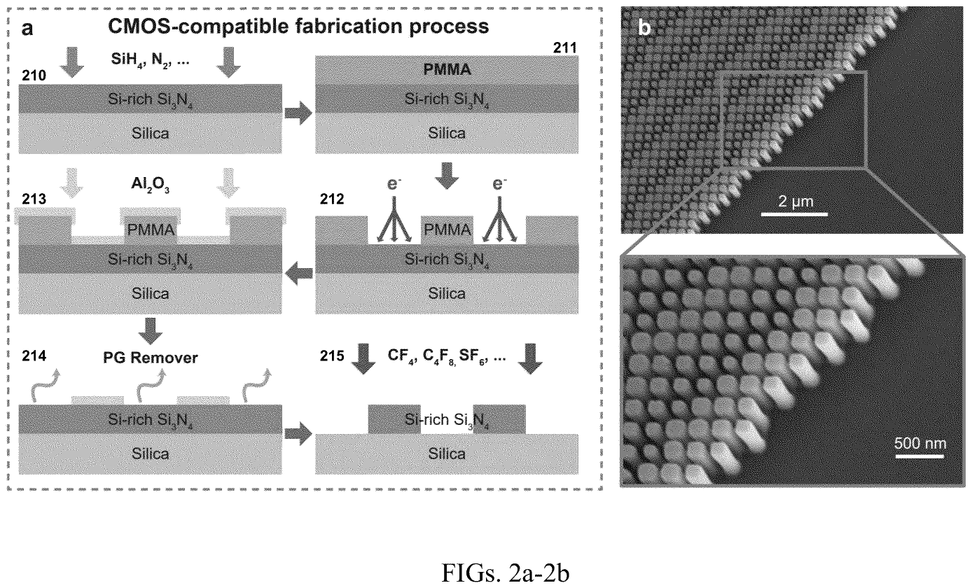

In certain embodiments, the SRN metasurfaces can be manufactured through a CMOS-compatible nanofabrication process, as illustrated in FIG. 2A. A 750-nm-thick SRN layer 210, with a designed refractive index of 2.3, can be deposited onto diced 500-μm-thick fused silica substrates. A two-layer resist 211 (for example, PMMA 495 k A4 and 950 k A2) can be spun-coated onto the SRN layer, and electron-beam lithography (EBL) can be conducted (for example, using Elionix ELS-G100) with a dose of 770 μC/cm² and a current of 2 nA. A 20-nm E-spacer 212 can be spun-coated onto the chip to prevent the electron charging effect caused by the non-conductive substrate during the EBL process. After exposure, the resist can be developed in a mixed solution of IPA:DI water=3:1 for 2 minutes. The developed resist can then be coated with a 25-nm thick Al₂O₃ layer 213 using electron-beam evaporation to serve as a hard mask for etching. The Al₂O₃ layer can then be lifted off in Remover PG 214, leaving a patterned mask on the SRN layer. This pattern can be etched into the SRN layer to form SRN nanopillars 215 using an inductively coupled plasma (ICP) etching system (for example, Oxford PlasmaPro 100 Cobra).

As illustrated by scanning electron microscope (SEM) images in FIG. 2B, the example fabricated metasurfaces show that the nanopillars can be defect-free—for example, the nanopillars can have uniform vertical side walls and consistent gap spacing therebetween. Defects can look like, for example, fallen over nanopillars and/or nanopillars which have stuck together—neither of which are illustrated by FIG. 2B.

Another dielectric platform can be titanium dioxide (TiO₂). Titanium-dioxide metasurfaces leverage TiO₂'s high refractive index (n≳2.4 at a wavelength of 520 nm) and negligible absorption to achieve high diffraction efficiencies and low losses across a broad band of wavelengths. This can provide high power-handling and compatibility with shorter optical wavelengths. TiO₂ can tolerate intensities above 2,000 W/mm². TiO₂ can theoretically generate over 1,000,000 tweezer traps.

In certain embodiments, the TiO₂ metasurfaces can be fabricated on 0.5-mm-thick, double-side-polished fused-silica wafers. A 700-nm ZEP-520A layer can be spin-coated and baked (for example, at 180° C. for 3 min). The thickness of the resist can be verified with a stylus profiler (for example, KLA P-17). After applying an E-spacer layer, the nano-pillar template can be written by 100 kV EBL (for example, using Elionix ELS-G100) with a current of 2 nA and a step size of 4 nm. The resist can be developed in chilled o-Xylene, rinsed in IPA, and nitrogen-dried, yielding apertures whose depth can set the final TiO₂ pillar height. Amorphous TiO₂ can be conformally deposited at 200° C. in an atomic-layer deposition (ALD) reactor (for example, Cambridge NanoTech Savannah) until the apertures are fully filled. Excess TiO₂ material on top can be removed by inductively coupled plasma (ICP) etching (for example, using Oxford PlasmaPro 100 Cobra) down to the resist surface. A final downstream plasma ashing (for example, using Matrix Plasma Asher) at 220° C. can remove the resist template and leave free-standing TiO₂ nanopillars on the fused-silica substrate.

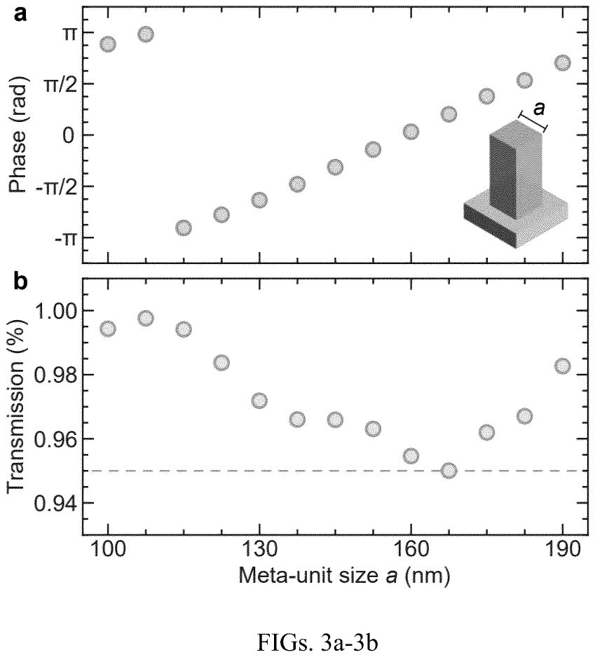

In certain embodiments, the pixel size of the nanopillars can be 290 nm. The height of the nanopillars can be 750 nm for SRN and 600 nm for TiO₂. The width of the nanopillars can range from 100 nm to 190 nm. For example, this can provide a comprehensive phase coverage over the 2π range at a wavelength of 520 nm, while maintaining near-unity transmission or forward scattering efficiency, as illustrated in FIGS. 3A-3B. The smallest nanopillar can have an edge width of 100 nm. The subwavelength width of the nanopillars and size of the pixels can yield high-resolution sampling, e.g., with a NA of 0.9.

Referring to FIG. 3A, phase response of the pixel library as a function of nanopillar width a is illustrated in FIG. 3A. Transmission or forward scattering efficiency of the pixel library is illustrated in FIG. 3B, where all pixels have a transmission over 95%.

In certain embodiments, the metasurface can assume the incidence of a flat phase front. The metasurface can also have a circular footprint to reduce diffraction effects of round input beams at its respective boundaries.

In certain embodiments, the metasurface can have diameters ranging from 1.16 mm (approximately 4000×4000 nanopillars) to 3.48 mm (approximately 12000×12000 nanopillars). The metasurface can handle optical intensities of at least 25 W/mm² (SRN) or 2,000 W/mm² (TiO₂) without active cooling. The metasurface can also have a diffraction efficiency of ˜60% and an effective NA of >0.6.

In certain embodiments, a laser beam can be sized slightly larger than the metasurface. For example, an input beam diameter of approximately 1.5 mm can be used for a metasurface with a diameter of 1.16 mm.

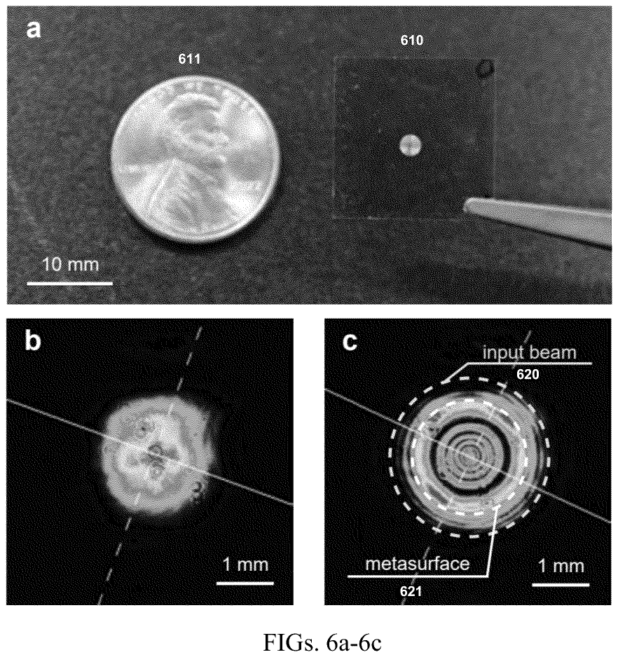

In certain embodiments, a 2.32 mm×2.32 mm laser beam with a 60% diffraction efficiency, laser power of about 130 W, and about 1 mW laser power per tweezer trap can generate approximately 80,000 tweezers arrays. A photo of a 2.32 mm×2.32 mm metasurface 610 by the side of an American one-cent coin 611 is illustrated in FIG. 6A. A profile of a 1.5-mm diameter beam that is incident onto the metasurface is illustrated in FIG. 6B. A far-field image of non-diffracted light after aligning the metasurface 621 to the beam 620 is illustrated in FIG. 6C.

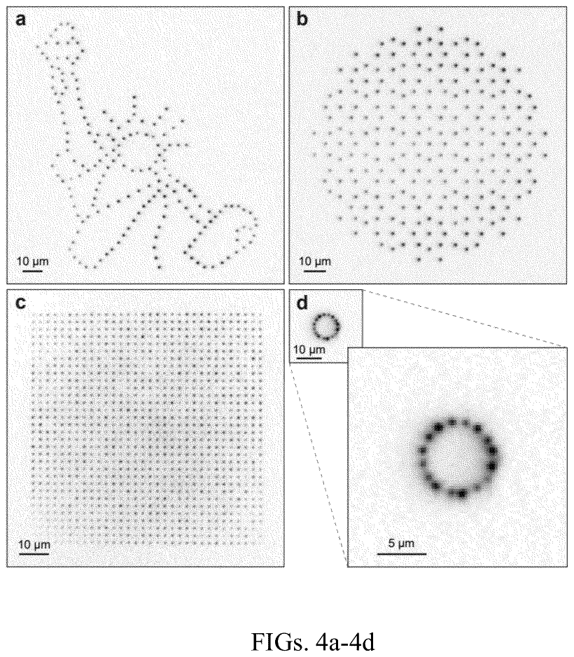

An example experimental setup for trapping optical tweezer arrays is illustrated in FIG. 1D. Referring to FIG. 1D, the optical tweezer arrays 129 can be projected into the glass cell 128 of an ultrahigh-vacuum chamber. Before illuminating a metasurface 122, a laser 120 at 520 nm can pass through an acousto-optic modulator (AOM) 121. This allows for fast switching and trap depth control. The substrate with the metasurface can be mounted on a two-axis translation stage. This allows for rapid switching between different array geometries with minimal realignment. For example, in certain embodiments, the array geometries can be fully arbitrary, quasicrystal, periodic, or circular. This is further illustrated throughout FIGS. 4A-4D. In certain embodiments, the tweezer array can be generated by the metasurface at one or more of its focal planes. The tweezer array can be converted into the optical momentum space by a microscope lens 123 (for example, having NA=0.6), relayed through a 1:1 telescope 124, and converted back into the tweezer array in the glass cell by an objective lens (for example, having NA=0.5). Light can be separated from the tweezer path via a long-pass dichroic mirror 125 and imaged on an EMCCD camera 126.

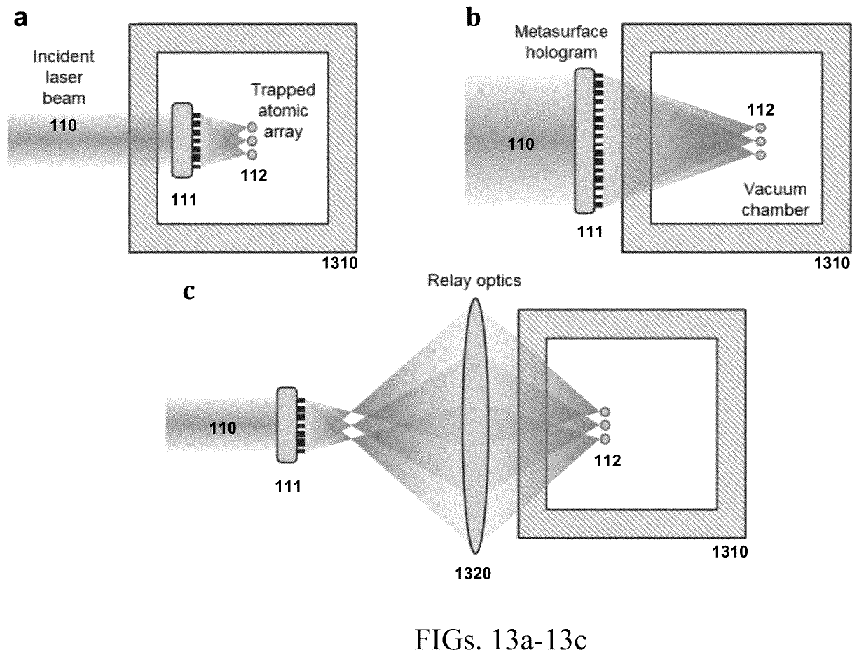

Referring to FIGS. 13A and 13B, the metasurface 111 can directly trap particles at one or more of its focal planes without the need for additional relay optics. In certain embodiments, the metasurface 111 is situated inside the vacuum chamber 1310, as illustrated in FIG. 13A. In alternative embodiments, the metasurface 111 is situated outside the vacuum chamber 1310, as illustrated in FIG. 13B. Referring to FIG. 13C, the metasurface 111 can directly trap particles at one or more of its focal planes with the assistance of relay optics 1320.

A strontium-level diagram is illustrated in FIG. 1C. Referring to FIG. 1C, particles can be loaded into the metasurface optical tweezer array from an ultracold cloud of ⁸⁸Sr atoms. In certain embodiments, the metasurface can be situated in an ambient environment. In certain embodiments, these particles can be cooled to microkelvin temperatures using standard techniques, such as laser cooling, evaporative cooling, and/or magneto-optical trapping. The particles can be transferred to a glass cell vacuum chamber via a push-beam where they can be captured and cooled to about 1 mK by a 3D MOT operating on the 461 nm transition. Simultaneously, two repump lasers at 679 nm and 707 nm, respectively, can close a loss channel present in the 461-nm cooling scheme. A second MOT on the narrow-line 689-nm transition can be used to further cool the particles. Transfer between MOTs can occur by broadening the frequency of the 689-nm line to 3 MHz to match the temperature distribution of the 461-nm MOT, before smoothly narrowing down to a single-frequency 689-nm MOT with on average 105 particles at 1 μK.

Optical tweezer arrays can be loaded at a trap depth of 100 μK. The trapping light can be provided by a 5-W optical power output, 520-nm wavelength laser. This laser can be generated via second harmonic generation (for example, using Azurlight, ALS-GR-520-5-A-CP-SF), seeded by an extended cavity diode laser operating at 1040 nm (for example, QPhotonics, QLD-1030-100S). In certain embodiments, the laser can have a power of 1-mW to 1-kW and generate wavelengths of 100-nm to 10-μm.

After the laser output, an acousto-optic modulator can dynamically control the trap depth of the tweezers. In front of the metasurface, a magnifying telescope can increase the beam waist to be larger than the area of the metasurface. After the metasurface, a high-power-capable microscope lens (for example, Thorlabs, LMH-50X-532, having NA>0.3) can collimate the generated pattern. The tweezer pattern can be relayed through a 1:1 telescope before being focused down onto the particles via an objective lens (for example, Mitutoyo, G Plan Apo 50X, having NA>0.3).

Fluorescence imaging can detect the trapped particles of the tweezer array. In certain embodiments, photons can be scattered on the 461-nm transition for 50 ms, collect the fluorescence through a high-NA objective lens that focuses the tweezers, separate the light from the tweezer path via a long-pass dichroic mirror, and image on an EMCCD camera (for example, Andor iXon Ultra 888). Imaging can be done with a 200-mm lens before the camera, such that a single camera pixel can correspond to a real space size of 260 nm×260 nm.

Referring to FIGS. 4A-4D, fluorescent images of atoms in different metasurface-generated tweezer arrays are presented. For example, FIG. 4A presents a fully arbitrary pattern (e.g., Statue of Liberty) with 183 traps and an average spacing of 3 μm. A phase-only hologram mask of the arbitrary pattern of FIG. 4A and corresponding tweezer array are presented in FIGS. 5A and 5B, respectively. FIG. 4B presents a quasicrystal pattern (e.g., Penrose tiling) with 225 traps and an average spacing of 4 μm. FIG. 4C presents a periodic 32×32 square lattice pattern with 1024 traps and an average spacing of 2.5 μm. FIG. 4D presents a Necklace pattern with 16 traps and average spacing of 1.45 μm.

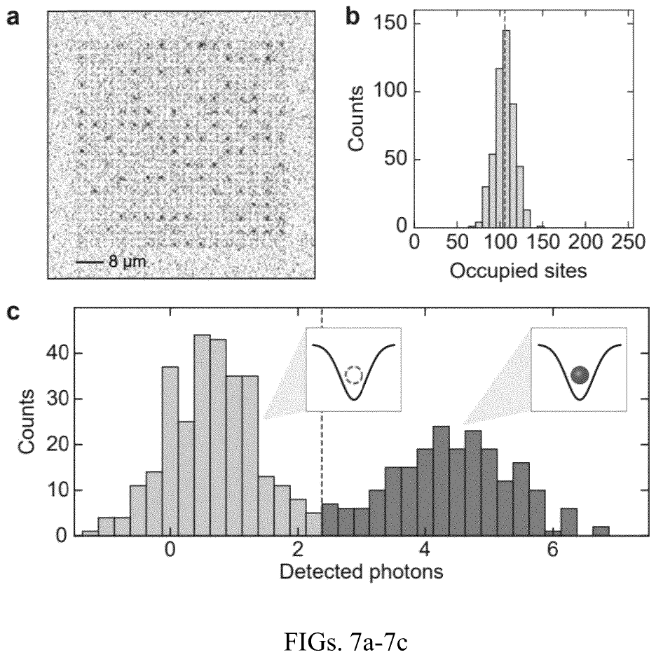

Referring to FIG. 7A, single particles can be trapped and detected in a 16×16 metasurface array. To load the array, each trap can be occupied by at least one particle. The number of particles can be random. For example, in certain embodiments, the number of particles can range from zero to ten. In certain embodiments, traps that initially have an odd number of particles can be turned into sites with one particle. In alternative embodiments, traps that initially have an even number of particles can be turned into sites with no particles. Photoassociation into an electronically excited molecular state of the species used, with corresponding atomic or molecular resonance of the species used, can induce pairwise particle loss. As a result, and now referring to FIG. 7B, 41% of the traps can contain a particle. This corresponds to more than 100 single particles in the 16×16 array.

While the particles are trapped, fluorescence imaging can be performed on strontium's 461 nm transition to determine the occupation in the array. Fluorescence photons can be collected with a low-noise camera and the photon number in the trap locations can be evaluated. Simultaneous cooling can increase or maximize the number of photons scattered per particle. For example, repulsive Sisyphus cooling on the 689 nm, m_{J}=±1 transition can counteract the recoil heating from repeated photon scattering on the 461 nm transition. Trap frequencies can be measured via parametric heating. The intensity of the tweezer light can be modulated sinusoidally with an amplitude of 5% for 30 ms while the frequency of the modulation is varied.

Referring to FIG. 7C, a histogram shows the detected photon numbers for a typical trap in the array. The histogram shows two peaks: one peak centered on zero photons, corresponding to zero particles, and a second peak centered on ˜4.5 photons, corresponding to a single particle. The absence of photon counts above the single-particle peak indicates no more than a single particle resides in the trap. The presence of photon counts between the zero- and single-particle peaks results from particle loss during imaging in the 520-nm traps. In alternative embodiments, different wavelengths yield similar results. For example, 597-, 813-, and 1064-nm wavelengths can be used.

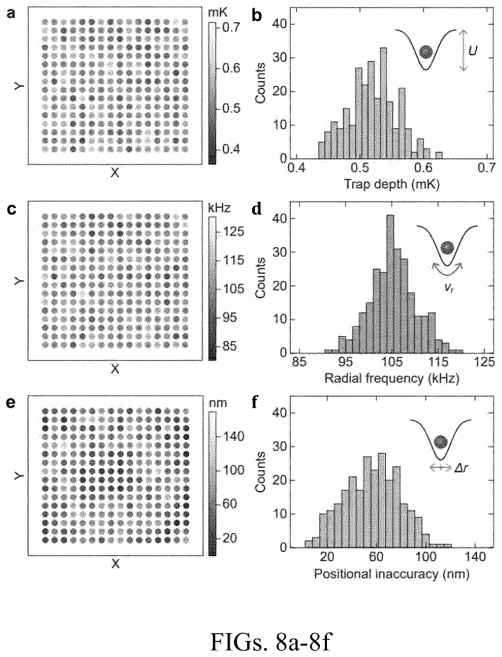

Referring to FIGS. 8A-F, the 16×16 array with 4 μm trap spacing displays high uniformity. High uniformity in trap depth and frequency ensures that the light shift and on-site vibrational modes are constant across the array. High accuracy of trap positions can allow for the precise control of particle-particle interactions. The uniformity in terms of trap depth, U, illustrated in FIG. 8A, radial trap frequency, vᵣ, illustrated in FIG. 8C, and trap positions, illustrated in FIG. 8D, is characterized for each trap in the array. FIG. 8B illustrates a histogram of the quantities observed for measuring trap depth uniformity, as shown in FIG. 8A. FIG. 8D illustrates a histogram of the quantities observed for measuring radial frequency uniformity, as shown in FIG. 8C. FIG. 8F illustrates a histogram of the quantities observed for measuring trap position uniformity, as shown in FIG. 8E.

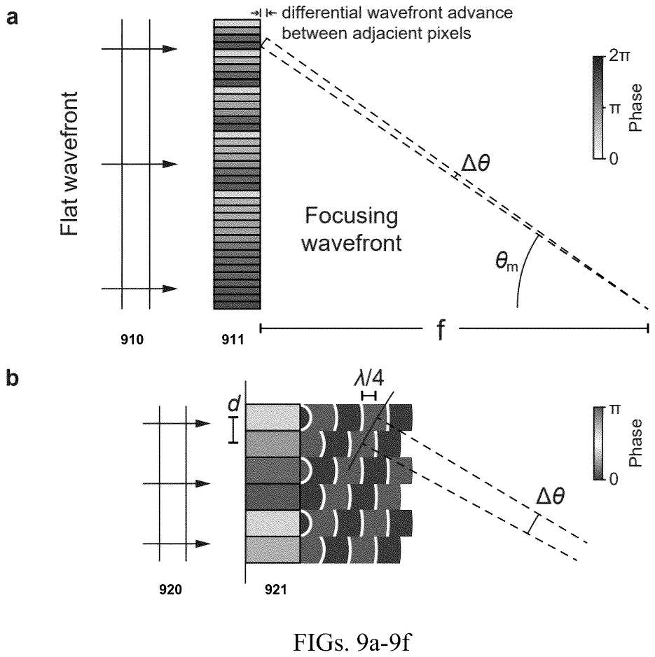

The dependence of the effective NA on pixel size and wavelength is illustrated in FIGS. 9A-9B. Referring to FIG. 9A, the phase profile of a lens with focal length f can be emulated by a pixelated phase mask. The individual pixels have a size d. A flat wavefront 910 can impinge on the device 911, and it can be converted into a focusing wavefront. θₘ is the maximal angle for which the phase advance between neighboring pixels stays smaller than π/2. The gray scale indicates the phase shift of the metasurface pixels.

Referring to FIG. 9B, the angle θₘ can be determined when the advance of wavefront 920 between neighboring pixels reaches λ/4 (corresponding to a phase shift of π/2). Δθ denotes the angular separation between neighboring pixels. The scale indicates the phase shift of the emerging wavefront behind the metasurface 921.

As disclosed herein, a high NA of a metasurface (for example, NA>0.3) can directly generate diffraction-limited traps on the micrometer scale in one or more of the focal planes of the metasurface.

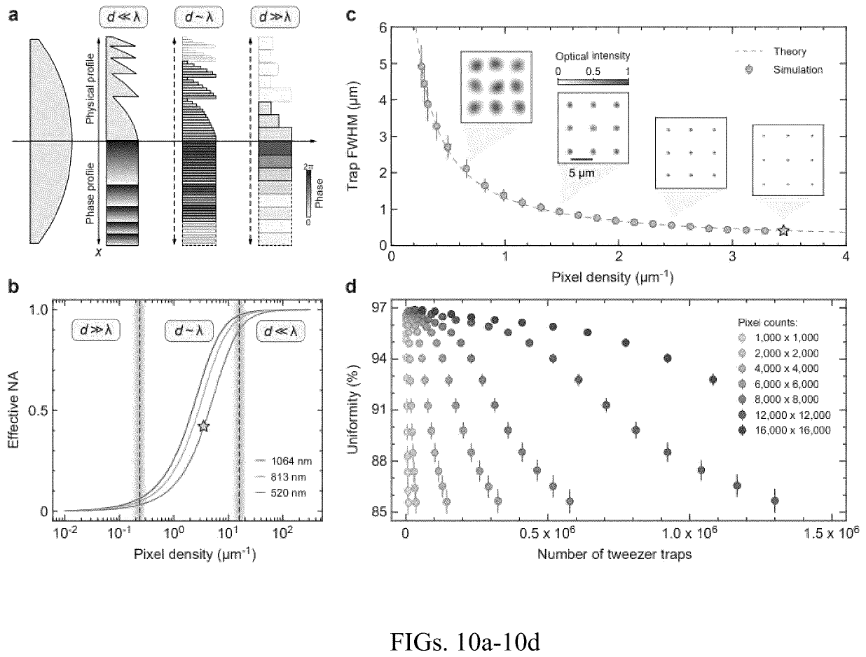

Referring to FIGS. 10A-10D, approximation of the phase profile of a spherical lens with infinitely small pixel size (d«λ), intermediate pixel size (d˜λ), and large pixel size (d»λ) is illustrated in FIG. 10A. For larger pixel sizes, the reproduction of steeper phase gradients ∂φ/∂x can limit the usable diameter of the device and reduce the effective NA.

Effective NA of a lens generated with a pixel-based device as a function of pixel density 1/d for common trapping wavelengths λ is illustrated in FIG. 10B. The dashed vertical lines indicate the approximate separation between the regimes d«A, d˜λ, and d»λ. The star indicates the pixel density for the metasurfaces. Focusing capabilities of pixel-based beam shaping devices are illustrated in FIG. 10C. For example, for a laser wavelength of 520 nm, a fixed device resolution of 300×300 pixels, and varying pixel density 1/d, an optimized 3×3 square array with 5 μm spacing can be generated. The tightness of the traps can be measured as the full-width-half-maximum (FWHM). Error bars show the standard deviation across the array. The pixel densities range from that of certain liquid crystal SLMs (for example, d=4 μm) to the holographic metasurface (yellow star, for example, d=290 nm). The dashed line shows a fit of the effective NA model.

Simulation of the uniformity of trap intensity as a function of the number of tweezer traps for device pixel counts ranging from 1,000×1,000 (light green) to 16,000×16,000 (dark blue) pixels is illustrated in FIG. 10D.

The normalized standard deviation of trap intensities as a function of the number of generated tweezers in the focal plane for device resolutions ranging from 1000×1000 to 16,000×16,000 pixels can be calculated. Uniformity can be 100% minus the standard deviation of the trap intensity across the array (in %). For example, the simulation can assume a pixel size of d=290 nm and an NA=0.6. The position of the focal plane can be determined by the hologram size (for example, resolution×pixel size) and the NA. The holograms can be optimized using FWHM in accordance with equation (1).

$$FWHM = α \times 0.51 λ \sqrt{1 + {( 4 d / λ )}^{2}} \qquad ( 1 )$$

A final forward propagation can be performed using the optimized holograms to calculate the tweezer array formed in the focal plane. The intensity profile for each tweezer can be integrated and the standard deviation for the entire array can be calculated.

Metasurfaces can provide small pixel sizes and large pixel numbers, enabling large and uniform tweezer arrays. Holographic metasurfaces with subwavelength pixels can generate optical tweezer arrays that are sufficiently tight at one or more of the focal planes of the metasurface for direct trapping of particles.

The small pixel size of metasurfaces can accommodate a large number of pixels within a compact device footprint. The number of high-quality traps that can be generated is positively correlated with the number of pixels.

In certain embodiments, a metasurface can have more than 8000×8000 pixels, generating over 200,000 traps. For example, traps can be arranged in a 600×600 square lattice (i.e., 360,000 traps) with trap spacing of 2.5 μm. The metasurface can have a diameter of 3.5 mm, contain approximately 114 million pixels, and be made of titanium dioxide. These traps display a high uniformity of at least 92%.

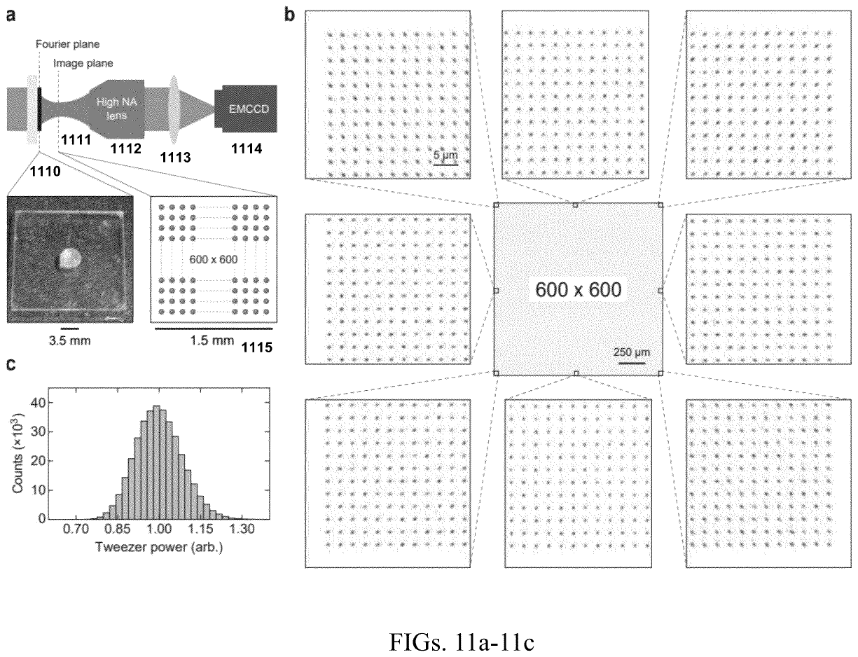

An example setup for optical characterization with a high NA (for example, NA=0.85) imaging objective 1112 is illustrated in FIG. 11A. For example, a 3.5 mm diameter TiO₂ metasurface 1110 in the Fourier plane can generate a 600×600 trap array 1115 in the focal plane 1111 of the metasurface, spanning a 1.5 mm×1.5 mm area, imaged on an EMCCD camera 1114. In certain embodiments, the EMCCD camera 1114 can include an imaging lens 1113.

This imaging system can compile a composite image from individual images. For example, the imaging system can compile a composite image from over 100 individual images. A composite image of the full array, stitched together from 126 individual high-resolution images, is illustrated in FIG. 11B. Here, eight high-resolution images of the edges are shown, illustrating the uniformity and quality of the traps in the array. The highly uniform traps are further illustrated in in FIG. 11C, which shows a histogram of trap uniformity of the optical intensity in individual tweezers. The total power can be determined by summing the local power in a region around each trap center.

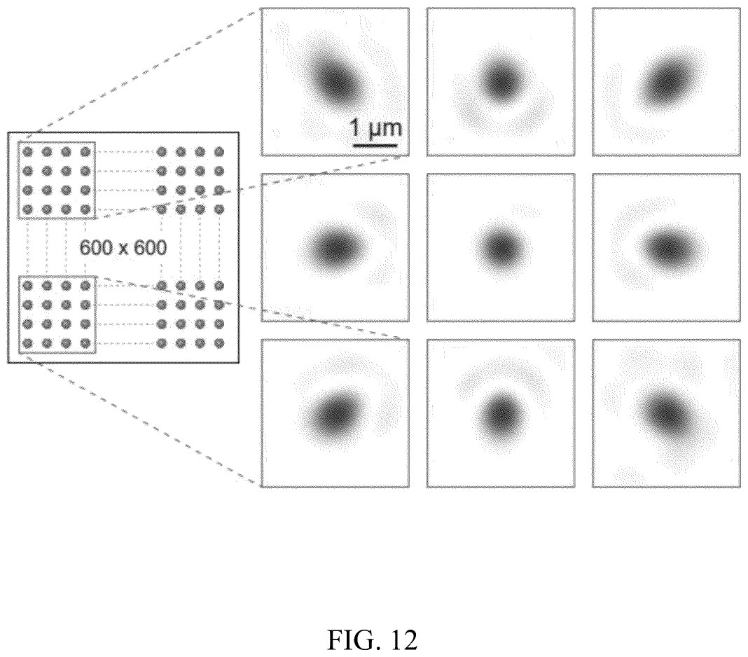

Images of averaged tweezer spots from the center and the edges of the array are illustrated in more detail in FIG. 12. Each image represents an average of approximately 300 traps. Tweezers at the array edges show a pinching as well as a weak halo oriented towards the center of the array.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within the spirit and scope of the disclosed subject matter.

What is claimed is:

1. A system for trapping ultracold particles therein using an incident laser beam, comprising:
a metasurface comprising a plurality of subwavelength-spaced pixels configured to imprint a phase profile on the incident laser beam;
wherein the metasurface is configured to generate an optical tweezer array from the incident laser beam;
wherein the metasurface is fabricated from one or more dielectric materials; and
wherein the optical tweezer array comprises a plurality of traps.

2. The system of claim 1, wherein the metasurface is configured to generate and focus the optical tweezer array.

3. The system of claim 1, wherein the metasurface is configured to generate the optical tweezer array in conjunction with focusing optics.

4. The system of claim 1, further comprising a vacuum chamber.

5. The system of claim 4, wherein the metasurface is located at a position selected from the group consisting of inside the vacuum chamber and outside the vacuum chamber.

6. The system of claim 4, further comprising relay optics, wherein the relay optics are positioned between the metasurface and the particles.

7. The system of claim 1, wherein the optical tweezer array is composed of an arbitrary geometry and an arbitrary dimensionality.

8. The system of claim 7, wherein the arbitrary dimensionality is selected from the group consisting of one-dimension, two-dimension, and three-dimension.

9. The system of claim 1, wherein the one or more dielectric materials have high refractive indexes.

10. The system of claim 2, wherein the metasurface has a numerical aperture greater than 0.3.

11. The system of claim 1, wherein the pixels have a cross-sectional size of approximately 5% to 100% of the wavelength of the incident laser beam and a height of approximately 10% to 300% of the wavelength of the incident laser beam.

12. The system of claim 1, wherein the incident laser beam has a wavelength from 100 to 10000 nanometers.

13. The system of claim 1, wherein the plurality of traps is configured to trap ultracold particles.

14. The system of claim 13, wherein the ultracold particles are strontium atoms.

15. The system of claim 1, wherein the plurality of traps has intensity uniformity greater than 90%.

16. The system of claim 1, wherein the plurality of traps comprises at least 10,000 traps.

17. A method for trapping single particles, comprising:
directing a laser beam onto a metasurface comprising subwavelength pixels;
modulating the phase of the laser beam using the metasurface, wherein the metasurface is configured to generate an optical tweezer array; and
trapping particles in the optical tweezer array.

18. The method of claim 17, wherein the metasurface is configured to generate and focus the optical tweezer array.

19. The method of claim 17, wherein the metasurface is configured to generate the optical tweezer array in conjunction with focusing optics.

20. The method of claim 17, further comprising detecting trapped particles by fluorescence imaging using a high-numerical-aperture lens and a camera.
